(19) United States
(12) Patent Application Publication
(10) Pub. No.: US 2005/0137505 A1
(43) Pub. Date: Jun. 23, 2005

(54) Nuero-muscular pressure point messager

(76) Inventor: Mary M. Munday, Houston, TX (US)

Correspondence Address: JAMES L. JACKSON;James L. Jackson, P.C., 10723 Sugar Hill Dr., Houston, TX, 77042, US

(21) Appl. No.: 11/011,386

(22) Filed: Dec. 14, 2004

Related U.S. Application Data
(60) Provisional application No. 60/531,072, filed on Dec. 19, 2003.

(51) Int. Cl. A61H 39/04

(52) U.S. Cl. 601/135

(57) ABSTRACT

A neuro-muscular pressure point massage system for personal use by a user for massaging desired areas of the body of the user. A pair of elongate generally rigid members each have a plurality of massager mounts situated along the length thereof. A connector element establishes releasable omnidirectional articulated connection of the elongate generally rigid members and permit the rigid members to be used in assembly and separated for independent use. At least one massage projection is removably mounted to at least one massager mount and is oriented for selective massaging contact with the body of the user. For massaging certain body areas, a hand held massager head defines at least one massager mount. A number of massage projections are selectively and releasably assembled singly or in groups to the massager mount and are oriented for selective massaging contact with the body of the user.

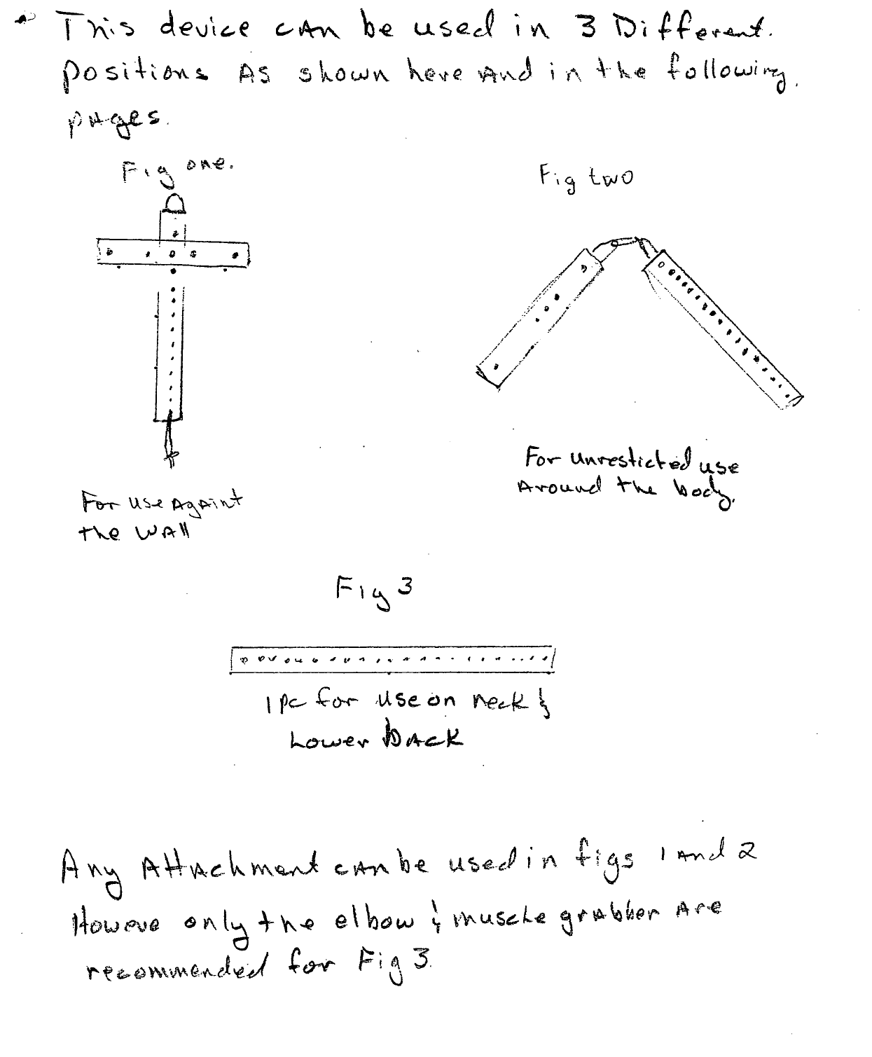

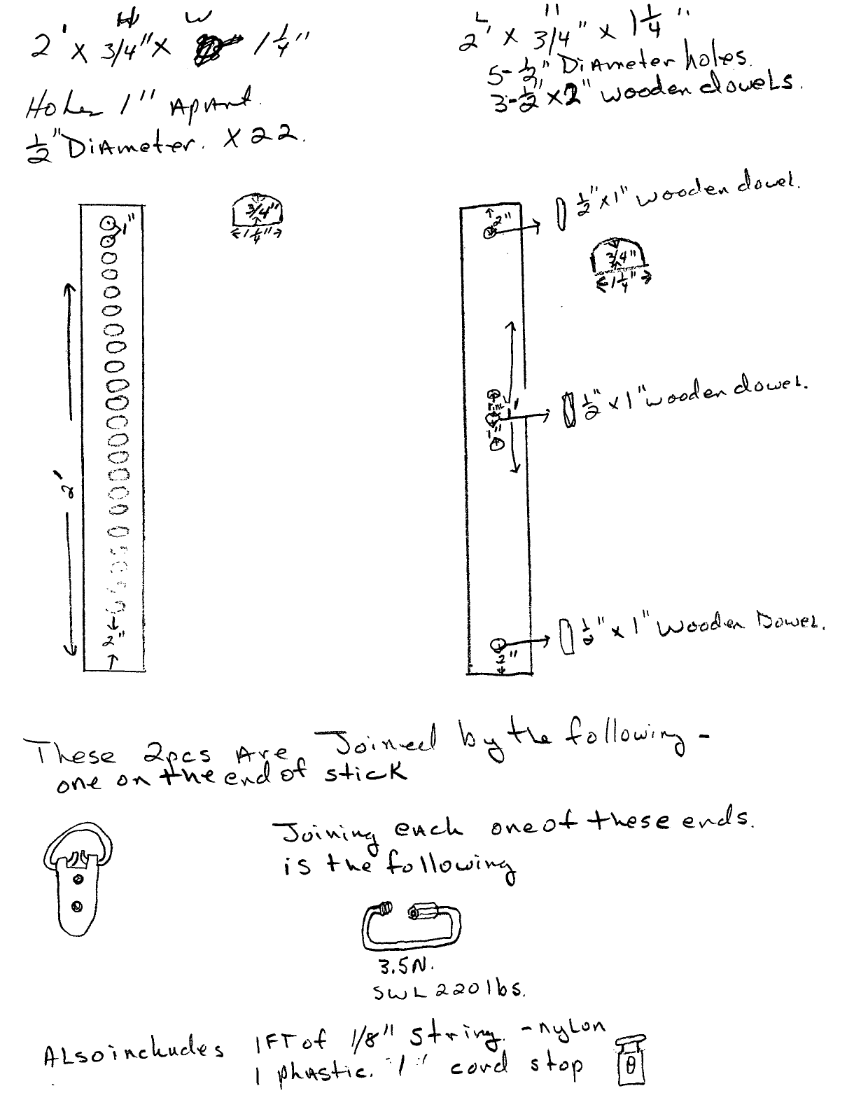

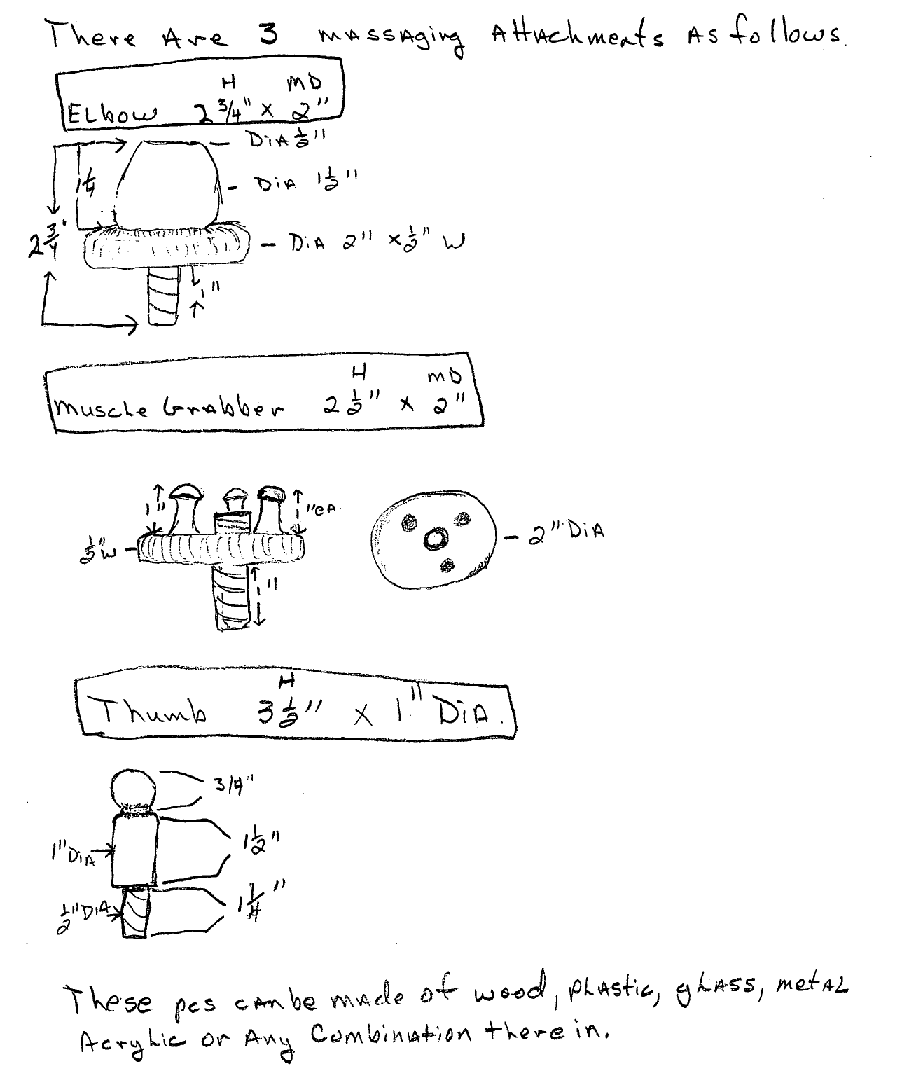

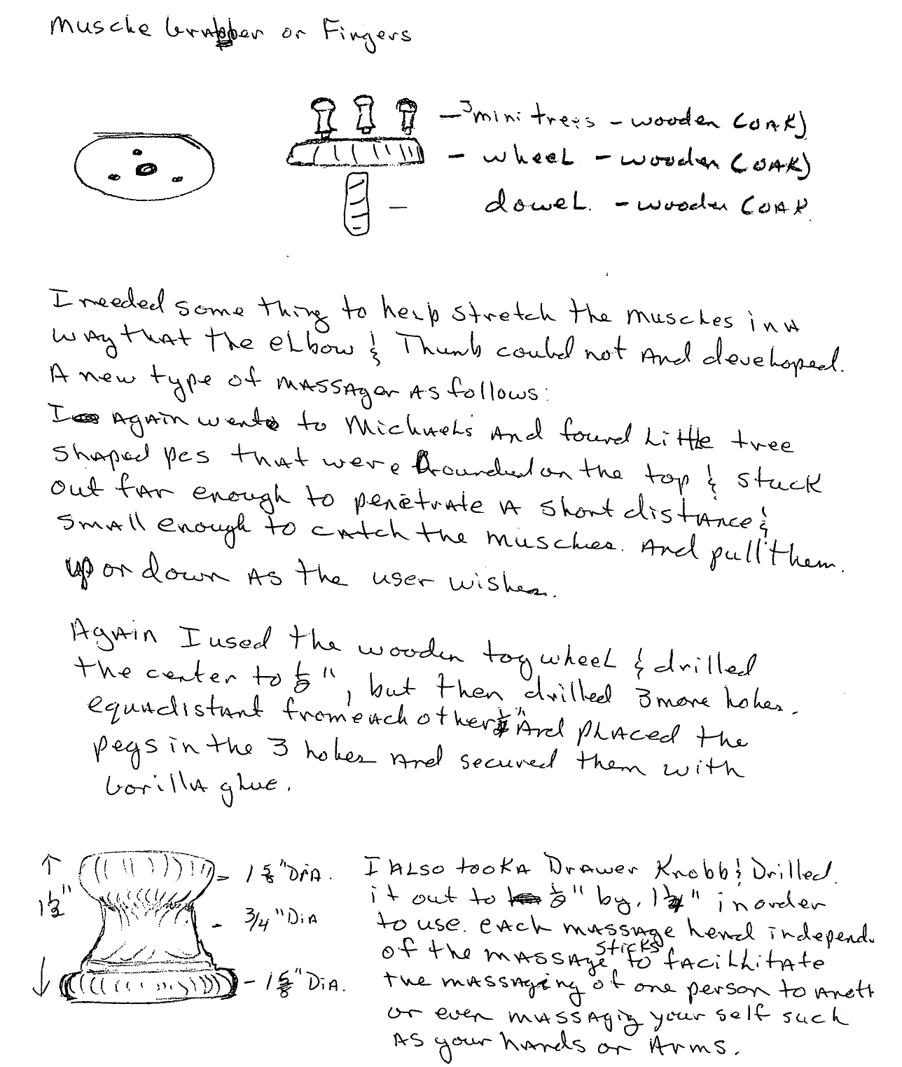

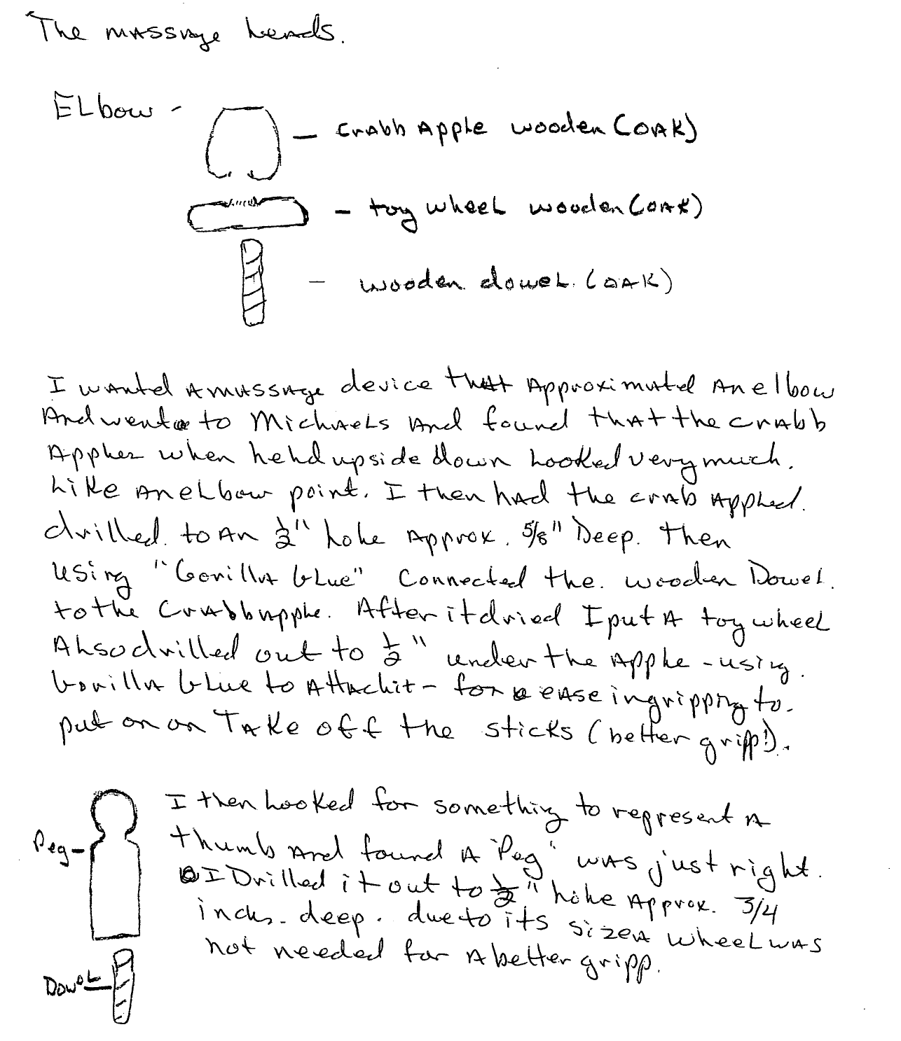

### RELATED PROVISIONAL APPLICATION

Applicant hereby claims the benefit of U.S. Provisional Patent Application No. 60/531,072, filed on Dec. 19, 2003 by Mary M. Munday and entitled “Nuero-Muscular Pressure Point Massager”.

### BACKGROUND OF THE INVENTION

### SUMMARY OF THE INVENTION

A neuro-muscular pressure point massage system for personal use by a user for massaging desired areas of the body of the user. A pair of elongate generally rigid members each have a plurality of massager mounts situated along the length thereof. A connector element establishes releasable omnidirectional articulated connection of the elongate generally rigid members and permit the rigid members to be used in assembly and separated for independent use. At least one massage projection is removably mounted to at least one massager mount and is oriented for selective massaging contact with the body of the user. For massaging certain body areas, a hand held massager head defines at least one massager mount. A number of massage projections are selectively and releasably assembled singly or in groups to the massager mount and are oriented for selective massaging contact with the body of the user.

DETAILED DESCRIPTION OF THE INVENTION

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A neuro-muscular pressure point massage system for personal use by a user for massaging desired areas of the body of the user, comprising:
a pair of elongate generally rigid members each having a plurality of messager mounts situated along the length thereof;
a connector element establishing releasable omnidirectional articulated connection of said elongate generally rigid members permitting said pair of elongate generally rigid members to be used in assembly and separated for independent use; and
at least one massage projection being removably mounted to at least one of said plurality of massager mounts of said elongate generally rigid members and being oriented for selective massaging contact with the body of the user.

2. A neuro-muscular pressure point massage system for personal use by a user for massaging desired areas of the body of the user, comprising:
a manually handled massage head defining at least one massager mount; and
a plurality of massage projections being selectively and releasably assembled to said at least one massager mount and being oriented for selective massaging contact with the body of the user.
